(19) United States
(12) Patent Application Publication
(10) Pub. No.: US 2003/0049349 A1
(43) Pub. Date: Mar. 13, 2003

(54) Isostatic mould die for pressing products in powder form, in particular for ceramic tiles

(75) Inventor: Pietro Rivola, Imola (IT)

Correspondence Address: BROWDY AND NEIMARK, P.L.L.C., 624 NINTH STREET, NW, SUITE 300, WASHINGTON, DC, 20001-5303, US

(73) Assignee: Sacmi-Cooperativa Meccanici Imola-Soc. Coop. A R.L., Imola (IT)

(21) Appl. No.: 10/235,482

(22) Filed: Sep. 6, 2002

(30) Foreign Application Priority Data
Sep. 7, 2001 (IT) RE2001U000031

(51) Int. Cl. B29C 43/10

(52) U.S. Cl. 425/405.2; 425/DIG. 44

(57) ABSTRACT

The die comprises a rigid body (20) having its upper surface (20′) covered by a flexible covering membrane (11) which defines the active surface of the die, and a plurality of seats (30) of vertical axis provided in the rigid body (20); within said seats (30) there is positioned a corresponding plurality of vertically slidable pistons (40) which have an active surface (40′) for acting on the material being pressed, and are disposed in contact with an operative liquid which fills the lower chambers (31) of the seats (30) and connects said chambers (31) together; said covering membrane (11) covers the active surface (40′) of the pistons (40), said pistons (40) acting on the material being pressed via the covering membrane (11). According to the invention each seat comprises abutment means (35) arranged to limit the stroke of the piston (40) in the direction of movement both towards the interior of the seat, and outwards from the seat (30).

This invention relates to moulds for pressing products in powder form, and more particularly to an improved isostatic die for ceramic tiles.

Isostatic dies are known to enable substantial improvements to be obtained with regard to density uniformity of the pressed product.

Those types of isostatic die which in practice present the best results comprise:

a rigid body having its upper surface covered by a flexible covering membrane which defines the active surface of the die;

a plurality of seats of vertical axis provided within the rigid body;

a corresponding plurality of pistons slidable vertically within said seats and having an active surface for acting on the material being pressed, and disposed in contact with an operative liquid which fills the lower chambers of the seats, to connect together said chambers;

said flexible covering membrane covering the active surface of the pistons, said pistons acting via the covering membrane on the material being pressed.

That membrane part positioned on the rigid body is fixed rigidly to it and represents 20-60% of the total surface.

In operation, when the die compresses the powder contained in the mould cavity and this is distributed non-homogeneously (whether on purpose or not), it happens that at the points of lesser density the piston emerges from the respective seat to cause a slight outward flexure in the membrane, whereas at the points of greater density the piston re-enters its seat to cause a slight inward flexure in the membrane. All the piston movements are linked together by the incompressible liquid which fills the lower chambers, the amount by which the piston projects outwards or inwards normally not exceeding a few tenths of a millimetre.

While the inward flexure movement is limited by the contact between the piston and the base of the lower chamber, the outward flexure movement is limited only by the mechanical strength of the membrane; and as the pressure of the liquid acting on the pistons reaches very high values, membrane yielding and tearing can occur, especially in limiting cases of localized low density, with consequent damage to the die, leakage of liquid and halting of the production line.

An object of this invention is to overcome the described drawback. This and further objects are attained by the invention as characterised in the claims.

The invention is based on the fact that each seat comprises abutment means arranged to limit the piston stroke in the direction of movement both towards the interior of the seat, and outwards from the seat.

The invention is described in detail hereinafter with the aid of the accompanying figures which illustrate one embodiment thereof by way of non-limiting example.

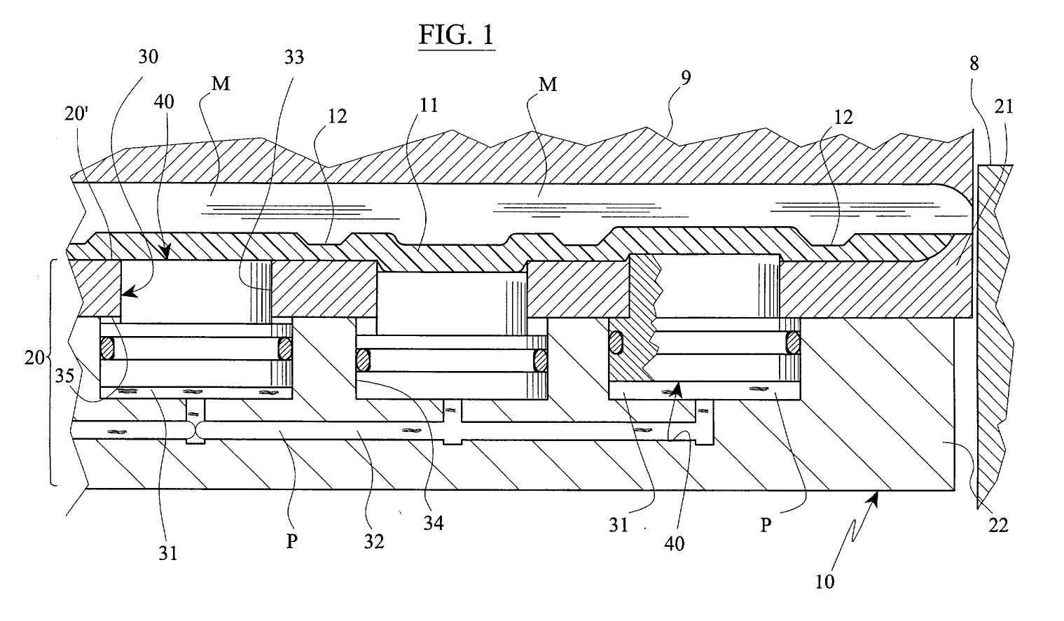

FIG. 1 is a section through the die of the invention, taken on a vertical plane.

FIG. 1A is an enlarged detail of FIG. 1.

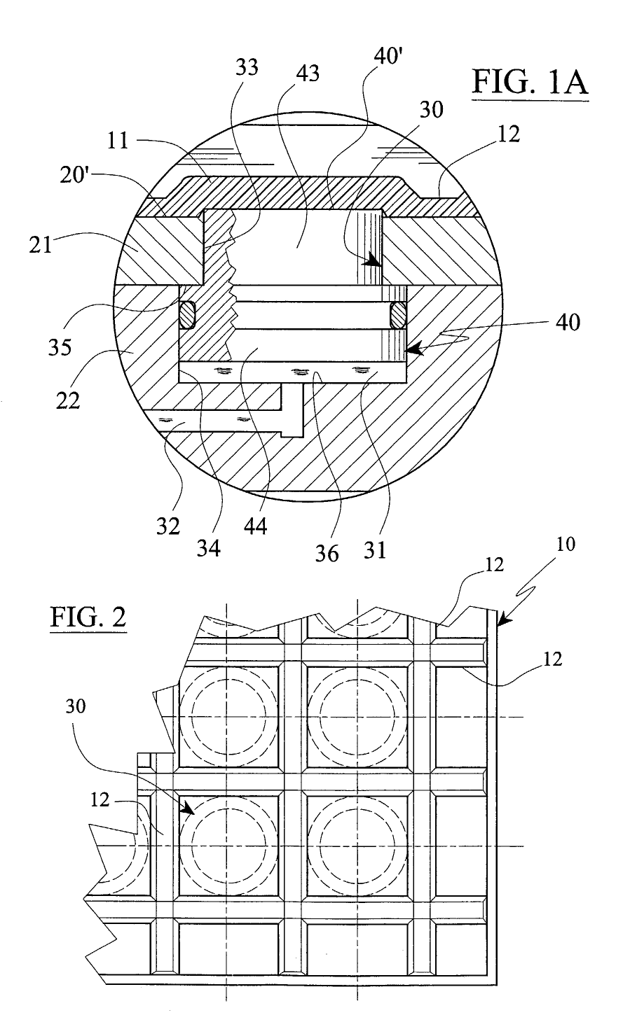

FIG. 2 is a plan view of FIG. 1 taken from above.

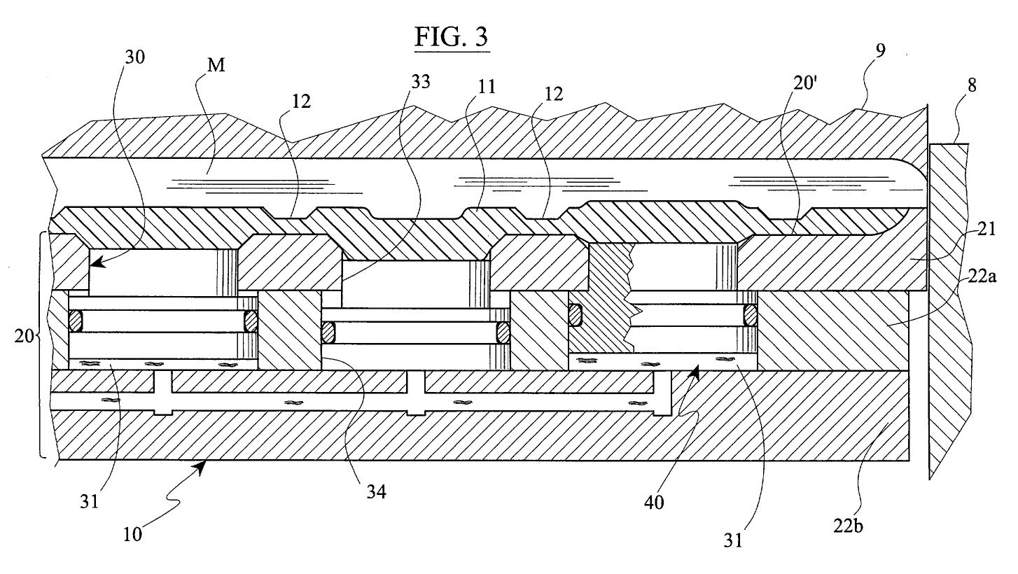

FIG. 3 is a section through a second embodiment of the invention, taken on a vertical plane.

The isostatic die of the invention, indicated overall by 10 in the figures, forms part of a mould, together with an opposing die 9 and a die plate 8.

For ease of description the invention is described and claimed with reference to the case in which the isostatic die 10 of the invention is the lower die of the mould; it is however apparent that the die of the invention can equally be the upper die of the mould.

The die 10 comprises a rigid body 20 having an overall flat horizontal upper surface 20′ covered by a flexible covering membrane (in particular of elastomeric material) which defines the active surface of the die 10.

Within the rigid body 20 there are provided a plurality of vertical-axis seats 30 having an axial surface (in particular cylindrical or prismatic) which open at their top at the upper surface 20′, where they are covered by the membrane 11.

In the seats 30 there are positioned a corresponding plurality of pistons 40 slidable vertically within the seats 30 and having an active upper surface 40′ for acting on the powder material M being pressed. In the lower part of the seats 30, below the pistons 40, there are defined lower chambers 31 containing operative liquid which comes into contact with the pistons; all the chambers 31 mutually communicate via a network of channels 32.

The membrane 11 covers the active upper surface 40′ of the pistons 40, said pistons acting on the material M being pressed via the membrane 11.

Specifically, the membrane 11 is fixed rigidly to those portions of the upper surface 20′ outside the seats 30, i.e. between one seat and another. The membrane 11 also comprises recesses 12 for forming in the tile a like number of usual projections (“feet” or the like) to improve the fixing of the tile to the support surfaces. The recesses 12 are provided in correspondence with said portions of the upper surface 20′ which do not comprise the seats 30.

According to the invention, each seat 30 comprises an upper first hole 33 (in particular cylindrical or prismatic) which opens at the upper surface 20′ of the rigid body 20 in contact with the covering membrane 11, and a coaxial lower second hole 34 (in particular cylindrical or prismatic) having a transverse dimension greater than the upper hole to form with it an upper shoulder 35.

The piston 40 likewise comprises an upper first portion 43 slidable within the upper hole 33, its upper surface defining the active upper surface 40′ of the piston, and a lower second portion 44 sealedly slidable within the lower hole 34.

The lower portion 44 is of lesser height than the lower hole 34 within which it slides, and is consequently able to move (through a travel stroke of a few tenths of a millimetre) upwards and downwards, limited in this by the lower base of the hole 34 and upperly by the shoulder 35.

The lower chamber 31 into which the operative liquid P is fed is defined in the lower part of the lower hole 34, below the piston. The piston is in geometrical relationship with the relative seat 30 such that when its lower portion 44 abuts against the upper shoulder 35, its upper portion 43 projects beyond the upper surface 20′ of the rigid body 20, by a predetermined amount which defines the maximum degree of outward flexure induced into the membrane 11.

In contrast, when the portion 44 of the piston abuts against the lower base 36 the active upper surface 40′ is below the upper surface 20″ of the rigid body by a predetermined amount which defines the maximum degree of inward flexure induced into the membrane 11. In this manner a precise mechanical limitation to inward flexure and, in particular, to outward flexure is achieved without the membrane 11 being excessively stressed.

In the embodiment shown in FIG. 1, the rigid body 20 is formed from two overlying plates, namely an upper plate 21 and a lower plate 22, mutually adjacent intimately along a flat common face and joined together by traditional demountable connection means. In the upper plate 21, to which the upper surface 20′ pertains, the upper holes 33 are provided, whereas the lower holes 34 and the channels 32 are provided in the lower plate 22.

This type of construction enables the die to be separated during repair/maintenance/regeneration into two parts, namely the upper plate 21 together with the membrane 11, and the lower plate 22 containing the entire hydraulic part, this being achieved without the need to disassemble the hydraulic part of the piston, to hence simplify and accelerate repair/maintenance/regeneration operations.

These advantages are equally present in the second embodiment shown in FIG. 3, which differs from the first substantially in the fact that the lower plate of the body 20 is further divided into two overlying plates 22a and 22b, mutually adjacent intimately along a flat common face (and joined together by traditional demountable connection means), in the first there being provided the lower holes 34 and in the second the channels 32.

According to a further embodiment (not shown in the figures), the upper portion 43 of the pistons 40 is separated from the lower portion 44 and simply rests on the lower surface thereof. This characteristic enables the upper portions 43 to be very easily and quickly replaced by others having a different axial dimension; and as this dimension determines the maximum outward flexure of the membrane, this characteristic makes it possible to very easily and quickly vary said maximum outward flexure, for example on the basis of the physical characteristics of the process or of the means used.

Numerous modifications of a practical and applicational nature can be made to the invention, but without deviating from the scope of the inventive idea as claimed below.

1. An isostatic mould die for pressing products in powder form, in particular for ceramic tiles, comprising:
a rigid body (20) having its upper surface (20′) covered by a flexible covering membrane (11) which defines the active surface of the die;
a plurality of seats (30) of vertical axis provided in the rigid body (20);
a corresponding plurality of pistons (40) vertically slidable within said seats (30), which have an active surface (40′) for acting on the material being pressed, and are disposed in contact with an operative liquid which fills the lower chambers (31) of the seats (30) and connects said chambers (31) together;
said covering membrane (11) covering the active surface (40′) of the pistons (40), said pistons (40) acting on the material being pressed via the covering membrane (11);
characterised in that each seat comprises abutment means (35) arranged to limit the stroke of the piston (40) in the direction of movement both towards the interior of the seat, and outwards from the seat (30).

2. A die as claimed in claim 1, characterised in that each seat (30) comprises an upper shoulder (35′) defining an abutment for limiting the upward stroke of the piston (40).

3. A die as claimed in claim 2, characterised in that each seat (30) comprises an upper first axial hole (33) which opens at the upper surface (20′) of the rigid body (20), and a lower second axial hole (34) having a transverse dimension greater than the first (33) to form therewith said upper shoulder (35), the relative piston (40) comprising an upper first portion (43) slidable within the upper hole (33), and a lower second portion (44) of lesser height than the lower hole (34) and sealedly slidable within this latter, the piston (40) being in geometrical relationship with the relative seat (30) such that when its second portion abuts against the upper shoulder (35), its upper portion (43) projects beyond the upper surface (20′) of the rigid body (20), by a predetermined amount.

4. A die as claimed in claim 1, characterised in that the rigid body (20) is formed from at least two overlying plates, namely an upper plate (21) and a lower plate (22), mutually adjacent intimately along a flat common face, the upper surface (20′) pertaining to the upper plate (21), in which the upper holes (33) are provided, the lower holes (34) and the channels (32) being provided in the lower plate (22).

5. A die as claimed in claim 1, characterised in that the upper portion (43) of the pistons (40) is separated from the lower portion (44) and simply rests on the upper surface of this latter.
